(19) United States
(12) Patent Application Publication
(10) Pub. No.: US 2023/0244591 A1
(43) Pub. Date: Aug. 3, 2023

(54) MONITORING STATUS OF NETWORK MANAGEMENT AGENTS IN CONTAINER CLUSTER

(71) Applicant: VMware, Inc., Palo Alto, CA (US)

(72) Inventors: Qian Sun, Beijing (CN); Danting Liu, Beijing (CN); Donghai Han, Beijing (CN); Wenfeng Liu, Beijing (CN); Salvatore Orlando, Naples (IT)

(21) Appl. No.: 17/696,366

(22) Filed: Mar. 16, 2022

(30) Foreign Application Priority Data
Feb. 1, 2022 (WO) PCTCN2022075299

(51) Int. Cl. G06F 11/34; G06F 9/50; G06F 9/54

(52) U.S. Cl. CPC G06F 11/3495; G06F 9/5033; G06F 9/547

(57) ABSTRACT

Some embodiments provide a method for monitoring a container cluster that includes multiple nodes on which application resources are deployed. The method deploys an agent on each node of a set of nodes of the cluster. Each agent is for configuring a logical network on the node to which the agent is deployed. The method monitors status of the deployed agents. Upon detection that a particular agent on a particular node is no longer operating correctly, the method prevents a container cluster control plane from deploying application resources to the particular node.

### BACKGROUND

The use of containers has changed the way applications are packaged and deployed, with monolithic applications being replaced by microservice-based applications. Here, the application is broken down into multiple, loosely coupled services running in containers, with each service implementing a specific, well-defined part of the application. However, the use of containers also introduces new challenges, in that the fleet of containers need to be managed and all these services and containers need to communicate with each other.

Management of the containers is addressed by container orchestration systems, such as Docker Swarm, Apache Mesos, or Kubernetes, the latter of which has become a de-facto choice for container orchestration. Kubernetes clusters can be run in an on-premises datacenter or in any public cloud (e.g., as a managed service or by bringing-up your own cluster on compute instances). Even when running applications on a Kubernetes cluster, an enterprise might want to be able to use a traditional network management system that configures logical networking for the applications deployed to the cluster (or across multiple clusters). A network management system that can interact with the Kubernetes control plane is important in such a scenario.

### BRIEF SUMMARY

Some embodiments provide a method for monitoring network management system agents deployed on nodes (i.e., hosts for containers) of a container cluster (e.g., a Kubernetes cluster) in which various application resources operate. In some embodiments, the method deploys agents on each node of a set of nodes of the cluster for the agents to configure logical networking on their respective nodes. The method monitors the status of these agents (e.g., via a control plane of the container cluster) and, upon detection that an agent is no longer operating correctly (e.g., if the agent has crashed), prevents the container cluster control plane (e.g., the Kube-API server of a Kubernetes cluster) from deploying application resources to the node with the inoperable agent.

In some embodiments, the method is performed by a first component of an external network management system that is deployed in the container cluster (e.g., as a Kubernetes Pod). This external network management system, in some embodiments, manages logical networking configurations for the application resources of an entity (e.g., an enterprise), both in the container cluster as well as in other deployments. The first network management system component deploys (i) the network management system agents on the nodes of the container cluster and (ii) a second network management system component in the container cluster (e.g., also deployed as a Pod) that translates data between the container cluster control plane and the external network management system (e.g., a management plane of said external network management system). For instance, when a user creates a new container in the cluster via the container cluster control plane and that control plane deploys the new container to the node, the second management plane component defines the logical network configuration for the new container and notifies the external network management system of the newly-defined logical network configuration.

The agents deployed on the nodes of the container cluster, in some embodiments, are replicable sets of containers (e.g., DaemonSets in a Kubernetes environment). In some embodiments, each agent includes both a first container that configures container network interfaces on their respective node to implement the logical network configuration for the application resources deployed to the node as well as a second container that translates cluster network addresses into network addresses for the application resources deployed on the node (e.g., cluster network addresses into Pod network addresses).

The first component of the external network management system monitors the status of the agents via the container cluster control plane in some embodiments. The container cluster control plane maintains the operational status of all of the containers deployed in the cluster and therefore maintains status information for the agents. The first network management system component can retrieve this information on a regular basis from the container cluster control plane or register with the cluster control plane to be notified of any status changes, in different embodiments. For instance, in a Kubernetes cluster, the Kube-API server exposes application programming interfaces (APIs) via which the network management system component is able to retrieve the status of specific Pods (i.e., the agents).

When an agent deployed on a node is no longer operating, logical networking cannot be properly configured for that node and thus application resources (containers) should no longer be deployed to that node until the agent becomes operational again. However, from the perspective of the container cluster control plane, non-operational agents are just non-operational containers (e.g., non-operational Pods) and thus there is no inherent reason to stop deploying resources to those nodes.

As such, upon detection that an agent is no longer operating, the network management system component (i) modifies a custom configuration resource used to track status of the agents and (ii) updates (e.g., via container cluster control plane APIs) a node conditions field maintained by the container cluster control plane for the nodes with non-operational agents. In some embodiments, the container cluster control plane maintains conditions information for each node in the cluster indicating whether networking is available for the node as well as whether memory and/or processing resources are overutilized. When the node conditions field for networking is set to indicate that networking is not available on a particular node, the container cluster control plane will (i) avoid deploying new containers to that particular node and (ii) move any containers running on the node to other nodes in the cluster. Once the network management system component detects that an agent has resumed operating, the component updates the node conditions field for that node to indicate that networking is again available in addition to modifying the custom configuration resources used to track agent status.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a container cluster.

FIG. 2 conceptually illustrates a process of some embodiments for monitoring agents and preventing a container cluster control plane from deploying any application resources to nodes on which the agent is not operating correctly.

FIG. 3 illustrates an example of a portion of the YAML code for a custom resource definition.

FIG. 4 illustrates an example of the conditions fields for an individual node when the node is fully operational.

FIG. 5 illustrates the conditions fields after the network management operator has modified the networking status conditions field to indicate that networking is unavailable because the agent on the node is not ready.

FIG. 6 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for monitoring network management system agents deployed on nodes (i.e., hosts for containers) of a container cluster (e.g., a Kubernetes cluster) in which various application resources operate. In some embodiments, the method deploys agents on each node of a set of nodes of the cluster for the agents to configure logical networking on their respective nodes. The method monitors the status of these agents (e.g., via a control plane of the container cluster) and, upon detection that an agent is no longer operating correctly (e.g., if the agent has crashed), prevents the container cluster control plane (e.g., the Kube-API server of a Kubernetes cluster) from deploying application resources to the node with the inoperable agent.

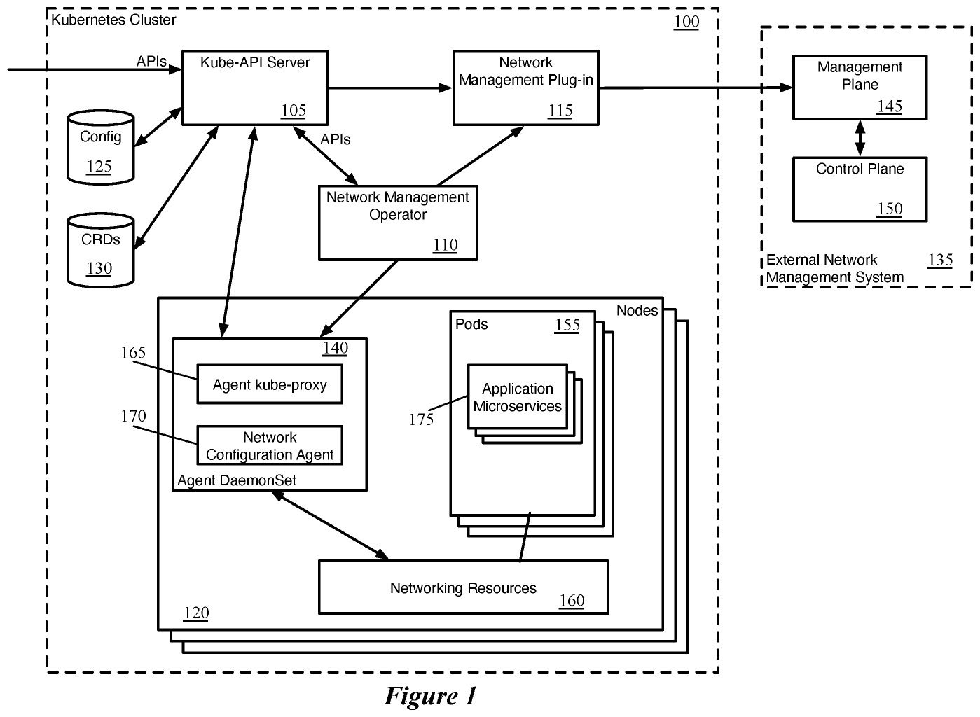

FIG. 1 conceptually illustrates such a container cluster 100—specifically, a Kubernetes cluster. As shown, the Kubernetes cluster 100 includes a Kube-API server 105, a network management operator 110, a network management plug-in 115, as well as one or more nodes 120. It should be noted that, although the Kube-API server 105 is the only Kubernetes control plane component shown in the figure, in many cases the Kubernetes cluster will include various other Kubernetes controllers (e.g., etcd, kube-scheduler) as well. In addition, although the Kube-API server 105 and the network management components 110 and 115 in the cluster 100 are shown as individual entities, the cluster may include multiple instances of each of these components. In some embodiments, the Kubernetes cluster includes one or more control plane nodes, each of which executes a Kube-API server 105, a network management operator 110, and a network management plug-in 115, as well as other Kubernetes control plane components. In other embodiments, the different components 105-115 may execute on different nodes.

The Kube-API server 105 is the front-end of the Kubernetes cluster control plane in some embodiments. The Kube-API server 105 exposes Kubernetes APIs to enable creation, modification, deletion, etc. of Kubernetes resources (e.g., nodes, Pods, networking resources, etc.) as well as to retrieve information about these resources. The Kube-API server 105 receives and parses API calls that may specify for various types of resources to be created, modified, or deleted. Upon receiving such an API call, the Kube-API server 105 either performs the requested action itself or hands off the request to another control plane component to ensure the requested action is taken (so long as it is a valid request). Some of these API calls are provided as YAML files that define the configuration for a set of resources to be deployed in the Kubernetes cluster. The API calls may also request information (e.g., via a get request), such as the status of a resource (e.g., a particular Pod or node), or modify such a status.

The Kube-API server 105 (or other back-end Kubernetes control plane components) maintains this resource status. In some embodiments, the configuration storage 125 stores cluster resource configuration and status information. This includes status information for nodes, Pods, etc. in the cluster in addition to other configuration data. The Kube-API server 105 also stores custom resource definitions (CRDs) 130, which define attributes of custom-specified resources that may be referred to in the API calls. For instance, various types of logical networking and security configurations may be specified using CRDs, such as definitions for virtual interfaces, virtual networks, load balancers, security groups, etc.

The network management operator 110 is a first component of an external network management system 135 that is deployed in the Kubernetes cluster 100. As mentioned, one or more instances of the network management operator 110 (e.g., as a Pod, container within a Pod, etc.) may execute on control plane nodes of the cluster 100 in some embodiments. In other embodiments, one or more instances of the network management operator 110 operate on one or more other nodes of the cluster 100, so long as the network management operator 110 is able to communicate with the Kube-API server 105.

The network management operator 110 is responsible for deploying the network management plug-in 115 as well as the network management agents 140 on each of the worker nodes 120 of the cluster. In some embodiments, a user (e.g., a network administrator or other user) deploys the network management operator 110 (e.g., through the Kubernetes control plane). The network management operator 110 in turn deploys the network management plug-in 115 and the network management agents 140. As discussed further below, the network management operator 110 also monitors the status of the network management agents 140 and prevents the Kubernetes control plane from scheduling application resources (e.g., Pods) to nodes 120 at which the network management agent 140 is not operating correctly.

The network management plug-in 115 translates data between the Kube-API server 105 (or other cluster control plane components) and the external network management system 135 (specifically, the management plane 145). The external network management system 135 may be any network management system. In some embodiments, the network management system 135 is NSX-T, which is licensed by VMware, Inc. This network management system 135 includes a management plane (e.g., a cluster of network managers) 145 and a control plane (e.g., a cluster of network controllers) 150. In some embodiments, the management plane 145 maintains a desired logical network state based on input from an administrator (either directly via the external network management system 135 or via the Kube-API server) and generates the necessary configuration data for managed forwarding elements (e.g., virtual switches and/or virtual routers, edge appliances) outside of the Kubernetes cluster 100 to implement this logical network state. In some embodiments, the management plane 145 directs the control plane 150 to configure any such managed forwarding elements to implement the logical network.

As noted, the network management plug-in 115 translates data from the cluster control plane for the management plane 145. For instance, when a user (e.g., a network administrator, an application developer, etc.) creates one or more new containers in the Kubernetes cluster 100 via the Kube-API server 105 (e.g., by defining an application to be deployed in the cluster 100), the Kubernetes control plane (e.g., a scheduler) selects a node or nodes for the new containers. The network management plug-in 115 defines the logical network configuration for these new containers and notifies the management plane 145 of the newly-defined logical network configuration so that this information can be incorporated into the logical network state stored by the management plane (and accessible to a user via an interface of the network management system 135).

In some embodiments, each of the worker nodes 120 is a virtual machine (VM) or physical host server that hosts one or more Pods 155, as well as various entities that enable the Pods to run on the node 120 and communicate with other Pods and/or external entities. As shown, these various entities include a set of networking resources 160 and the network management agents 140. Other components will typically also run on each node, such as a kubelet (a standard Kubernetes agent that runs on each node to manage containers operating in the Pods 155).

The networking resources 160 may include various configurable components, which can either be the same on each node (though often configured differently) or vary from node to node. The networking resources, in some embodiments, include one or more container network interface (CNI) plugins as well as the actual forwarding elements and tables managed by these plugins. For instance, in some embodiments, the CNI plugin (or an agent thereof) on a node 120 is responsible for directly managing the instantiation of a forwarding element (e.g., Open vSwitch) on that node, configuring that forwarding element (e.g., by installing flow entries based on the logical network configuration), creating network interfaces for the Pods 155, and connecting those network interfaces to the forwarding elements. The networking resources 160 can also include standard Kubernetes resources such as iptables in some embodiments.

Each of the Pods 155, in some embodiments, is a lightweight VM or other data compute nodes (DCN) that encapsulates one or more containers that perform application micro-services 175. Pods may wrap a single container or a number of related containers (e.g., containers for the same application) that share resources. In some embodiments, each Pod 155 includes storage resources for its containers as well as a network address (e.g., an IP address) at which the pod can be reached.

The network management agents 140, as mentioned, are deployed on each node 120 by the network management operator 110. In some embodiments, these agents 140 are replicable sets of containers (i.e., replicable Pods). Specifically, in some embodiments, a DaemonSet (a standard type of Kubernetes resource) is defined through the Kube-API server 105 for the agent. As shown, each agent 140 includes two containers—an agent kube-proxy 165 and a network configuration agent 170. The agent kube-proxy 165 in some embodiments is a network management system-specific variation of the standard kube-proxy component, which is responsible for implementing the Kubernetes service abstraction by translating cluster network addresses into network addresses for the application resources deployed on the node (e.g., cluster IP addresses into Pod IP addresses). The network configuration agent 170, in some embodiments, configures the networking resources 160 (e.g., the CNIs) on the node 120 to ensure that these networking resources implement the logical network configuration for the application resources implemented on the Pod 155.

The network management operator 110, in addition to deploying the network management plug-in 115 and the agents 140, monitors these agents via the Kube-API server 105. When an agent 140 deployed on a node is no longer operating for any reason, logical networking cannot be properly configured for that node and thus the Pods 155 on which application micro-services 175 run should no longer be deployed to that node 120 until its agent 140 becomes operational again. However, from the perspective of the Kubernetes cluster control plane, non-operational agents are just non-operational Pods and thus there is no inherent reason to stop deploying resources to those nodes. Thus, the network management operator 110 also ensures that the Kubernetes control plane stops deploying Pods to nodes 120 with agents 140 that are not currently operational.

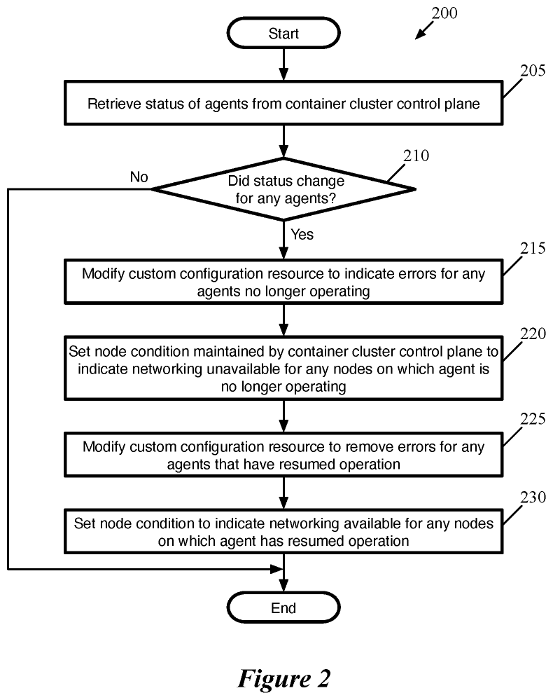

FIG. 2 conceptually illustrates a process 200 of some embodiments for monitoring the agents and preventing the container cluster control plane (e.g., the Kubernetes control plane) from deploying any application resources (e.g., Pods) to nodes on which the agent is not operating correctly. In some embodiments, the process 200 is performed by a component of an external network management system, such as the network management operator 110 shown in FIG. 1. In some such embodiments, the component that performs the process 200 is also the component that deploys the agents.

As shown, the process 200 begins by retrieving (at 205) the status of the deployed agents from the container cluster control plane. In some embodiments, the container cluster control plane (e.g., either the front-end Kube-API server or a back-end control plane component) maintains information that indicates the operational status of all of the containers deployed in the cluster. This control plane provides APIs that enable a user (in this case, the network management component) to retrieve the operational status of these agents. In some embodiments, the API request from the network management operator specifies each agent by name, while in other embodiment the API request uses the name of the DaemonSet to request information for each deployed instance of that DaemonSet. In some embodiments, the network management operator performs the process 200 on a regular basis (e.g., at regular time intervals). In other embodiments, the network management operator subscribes with the Kube-API server for updates to the status of each deployed agent in the cluster.

The process 200 then determines (at 210) whether the status has changed for any of the agents. For example, if the agent on a node was previously not operational, then if the node remains non-operational, no further action needs to be taken. However, if that agent is then identified as having resumed operation, the network management operator will take action so that the corresponding node can be again used for deployment of Pods. Similarly, if the agent on a node was previously operational but is no longer operational, additional actions are required to prevent Pods from being deployed to that node. If the status has not changed for any of the agents, then the process 200 ends (until another iteration of the process retrieves the status information again).

If the status has changed for at least one of the agents (i.e., an agent has gone from operational to non-operational or vice versa), then the network management operator performs a set of operations for each such agent. In some embodiments, the network management operator (i) modifies a custom configuration resource used to track status of the agents and (ii) updates a node conditions field maintained by the container cluster control plane for the nodes whose agents have changed status to indicate whether networking is available on those nodes.

Specifically, as shown in the figure, the process 200 modifies (at 215) the custom configuration resource to indicate errors for any agents that are no longer operating. In some embodiments, this custom configuration resource is a custom resource defined by the network management operator within the Kubernetes control plane to configure the network management plug-in and the network management agents on the node. The custom configuration resource defines the configuration for running the network management plug-in Pod(s) and the DaemonSet of the network management agents.

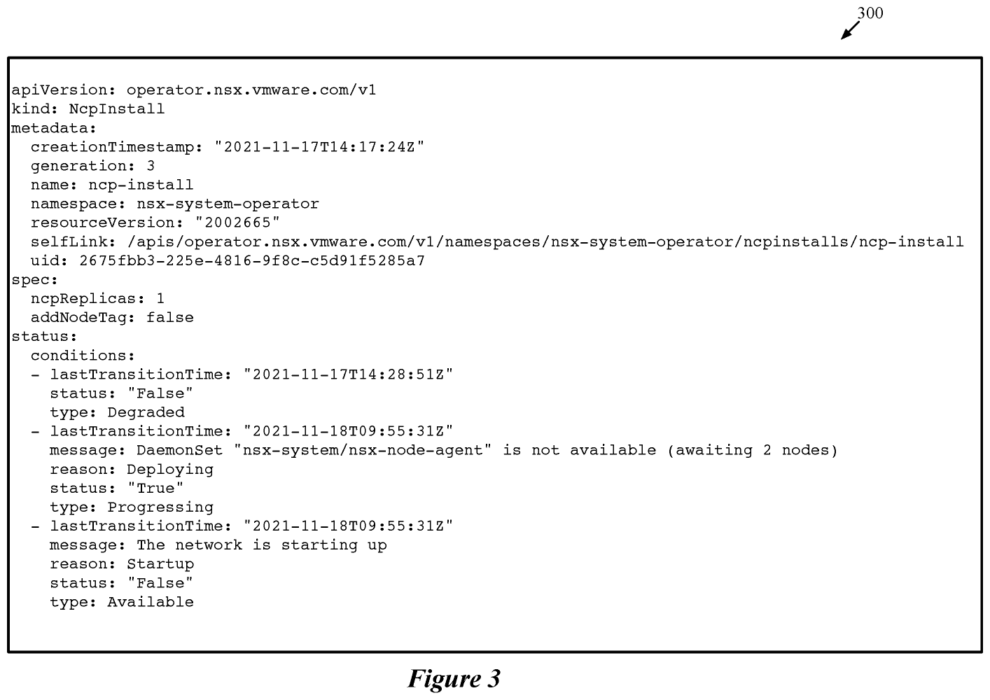

FIG. 3 illustrates an example of a portion of the YAML code for such a custom resource definition 300. Here, the custom resource definition is referred to as NcpInstall, and defines conditions which indicates the status of the network management components managed by the network management operator. In some embodiments, only one of the conditions Degraded, Progressing, and Available can be marked True at once. In some embodiments, if either Degraded or Progressing is indicated as True (rather than Available), then at least one node agent is not operating correctly. In the example, the Progressing condition has been marked as True (and correspondingly the Available condition marked as False) because the node agent is not available on two nodes. On the other hand, when all of the node agents are available, the Available condition would be marked as True while the Degraded and Progressing conditions would be marked as False. In some embodiments, the network management operator modifies the conditions on this resource via API calls to the Kube-API server.

The process 200 also sets (at 220) a node condition maintained by the container cluster control plane to indicate that networking is not available for any nodes on which the agent is no longer operating. In some embodiments, the network management operator modifies this node condition via an API request to the Kube-API server. In some embodiments, the cluster control plane maintains a set of conditions fields for each node in the cluster indicating whether networking is available for the node as well as whether memory and/or processing resources are overutilized.

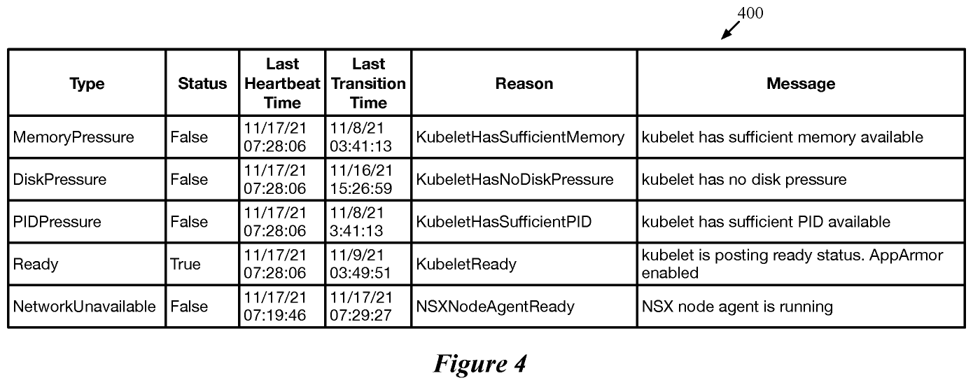

FIG. 4 illustrates an example of the conditions fields 400 for an individual node when the node is fully operational. As shown, the conditions include five fields. In the optimal case, the MemoryPressure (whether memory on the node is low), DiskPressure (whether disk capacity on the node is low), PIDPressure (whether there are too many processes running on the node thereby taxing processing capability), and NetworkUnavailable (whether the network is not correctly configured on the node) fields should be set to False. On the other hand, the Ready field should optimally be set to True, indicating that the node is healthy and ready to accept Pods.

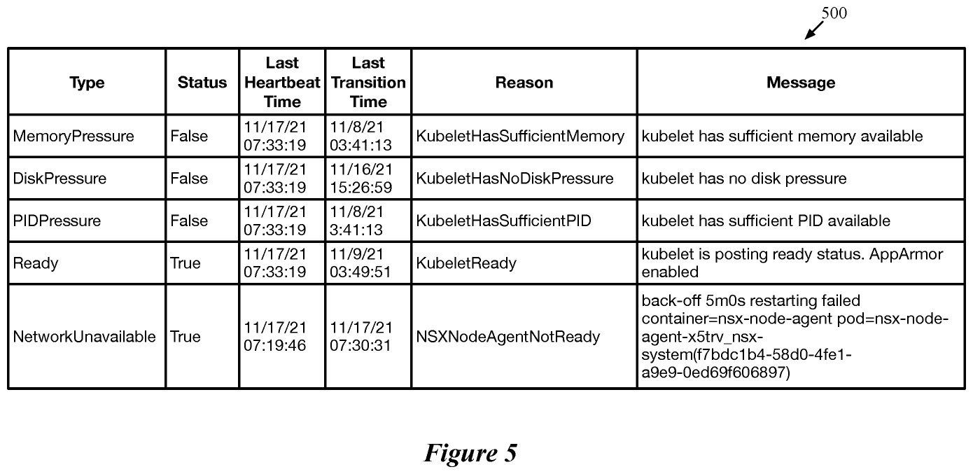

FIG. 5 illustrates these conditions fields 500 after the network management operator has modified the networking status conditions field to indicate that networking is unavailable because the agent on the node (nsx-node-agent) is not ready. As shown, the last time the network management operator was able to communicate with the agent is (the last heartbeat time) is noticeably earlier than the last time the cluster control plane was able to communicate with the kubelet on that node. The network management operator therefore changes the status of the NetworkUnavailable conditions field to True, modifies the last transition time, and provides a reason and message (that the agent on the node is not ready).

As a result, the Kubernetes control plane will not deploy any Pods to the node(s) on which the agent is not operating. In addition, in some embodiments, the Kubernetes control plane reassigns any Pods that are currently running on these nodes to other nodes in the cluster that are fully operational. In some embodiments, the Kube-API server detects when the conditions field for a node has been changed to indicate that networking is unavailable and adds a taint to the node so that Pods will not be scheduled to that node.

Returning to FIG. 2, the process 200 also modifies (at 225) the custom configuration resource to remove errors for any agents that have resumed proper operation. As described above, in some embodiments, this custom configuration resource is a custom resource defined by the network management operator within the Kubernetes control plane to configure the network management plug-in and the network management agents on the node. For instance, with respect to the Ncpinstall resource shown in FIG. 3, if all of the agents were operational, the network management operator of some embodiments would modify the conditions such that Available was now indicated as True and the other conditions were indicated as False.

In addition, the process 200 sets (at 230) the node condition maintained by the container cluster control plane to indicate that networking is again available for any nodes on which the agent has resumed operation. In some embodiments, the network management operator modifies this node condition via an API request to the Kube-API server. Specifically, the NetworkUnavailable field for any node on which the agent was operational would be marked as False (as shown in FIG. 4), indicating to the Kubernetes control plane that networking is again available on that node. This causes the control plane to remove the taint set on that node and to resume deploying Pods to the node.

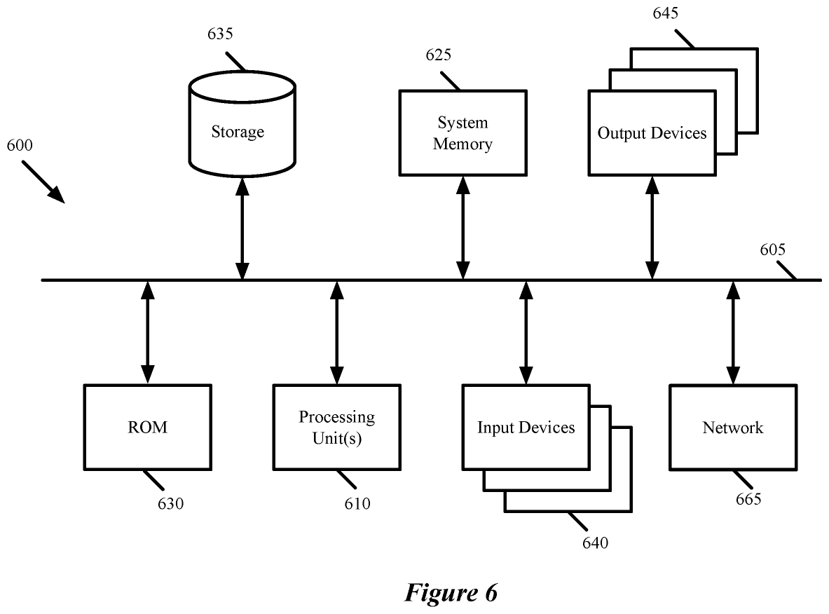

FIG. 6 conceptually illustrates an electronic system 600 with which some embodiments of the invention are implemented. The electronic system 600 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the electronic system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments.

The read-only-memory (ROM) 630 stores static data and instructions that are needed by the processing unit(s) 610 and other modules of the electronic system. The permanent storage device 635, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 635.

Other embodiments use a removable storage device (such as a floppy disk, flash drive, etc.) as the permanent storage device. Like the permanent storage device 635, the system memory 625 is a read-and-write memory device. However, unlike storage device 635, the system memory is a volatile read-and-write memory, such a random-access memory. The system memory stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices enable the user to communicate information and select commands to the electronic system. The input devices 640 include alphanumeric keyboards and pointing devices (also called “cursor control devices”). The output devices 645 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 6, bus 605 also couples electronic system 600 to a network 665 through a network adapter (not shown). In this manner, the computer can be a part of a network of computers (such as a local area network (“LAN”), a wide area network (“WAN”), or an Intranet, or a network of networks, such as the Internet. Any or all components of electronic system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 2) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method for monitoring a container cluster comprising a plurality of nodes on which a plurality of application resources are deployed, the method comprising:
deploying an agent on each node of a set of nodes of the cluster, each agent for configuring a logical network on the node to which the agent is deployed;
monitoring status of the deployed agents; and
upon detection that a particular agent on a particular node is no longer operating correctly, preventing a container cluster control plane from deploying application resources to the particular node.

2. The method of claim 1 further comprising deploying, to a node of the container cluster, a management plane application that translates between the container cluster control plane and a management plane external to the container cluster that manages the logical network.

3. The method of claim 2, wherein when a user creates a new container via the container cluster control plane and the container cluster control plane deploys the new container to a node, the management plane application (i) defines logical network configuration for the new container and (ii) notifies the external management plane of the logical network configuration defined for the new container.

4. The method of claim 3, wherein the management plane application provides the defined logical network configuration for the new container to the agent deployed on the node on which the new container is deployed, wherein the agent configures networking resources on the node to implement the defined logical network configuration.

5. The method of claim 1, wherein each respective agent on a respective node comprises a respective first container that configures container network interfaces on the respective node to implement logical network configuration and a respective second container that translates cluster network addresses into network addresses for application resources deployed on the node.

6. The method of claim 1, wherein:
each agent is deployed as a set of containers; and
monitoring status of the deployed agents comprises communicating with the container cluster control plane to retrieve status of the deployed agents.

7. The method of claim 6, wherein the container cluster control plane provides a set of application programming interfaces (APIs) via which the status of the deployed agents is retrieved.

8. The method of claim 1, wherein preventing the container cluster control plane from deploying application resources to the particular node comprises (i) modifying a custom configuration resource used to track status of the agents and (ii) modifying a conditions field stored by the container cluster control plane for the particular node to indicate that networking is not available on the particular node.

9. The method of claim 8, wherein when the conditions field indicates that networking is not available on the particular node, the container cluster control plane (i) does not deploy new containers to the particular node and (ii) moves any containers running on the particular node to other nodes in the container cluster.

10. The method of claim 1, wherein the container cluster is a Kubernetes cluster and each deployed agent is an instance of a replicable Pod.

11. The method of claim 10, wherein each deployed agent is an instance of a DaemonSet defined for the Kubernetes cluster.

12. The method of claim 10, wherein the method is performed by a Pod deployed on a node in the cluster, wherein the Pod communicates with a Kube-API server of the cluster to monitor status of the deployed agent Pods.

13. A non-transitory machine-readable medium storing a program which when executed by at least one processing unit monitors a container cluster comprising a plurality of nodes on which a plurality of application resources are deployed, the program comprising sets of instructions for:
deploying an agent on each node of a set of nodes of the cluster, each agent for configuring a logical network on the node to which the agent is deployed;
monitoring status of the deployed agents; and
upon detection that a particular agent on a particular node is no longer operating correctly, preventing a container cluster control plane from deploying application resources to the particular node.

14. The non-transitory machine-readable medium of claim 13, wherein the program further comprises a set of instructions for deploying, to a node of the container cluster, a management plane application that translates between the container cluster control plane and a management plane external to the container cluster that manages the logical network, wherein when a user creates a new container via the container cluster control plane and the container cluster control plane deploys the new container to a node, the management plane application (i) defines logical network configuration for the new container and (ii) notifies the external management plane of the logical network configuration defined for the new container.

15. The non-transitory machine-readable medium of claim 14, wherein the management plane application provides the defined logical network configuration for the new container to the agent deployed on the node on which the new container is deployed, wherein the agent configures networking resources on the node to implement the defined logical network configuration.

16. The non-transitory machine-readable medium of claim 13, wherein each respective agent on a respective node comprises a respective first container that configures container network interfaces on the respective node to implement logical network configuration and a respective second container that translates cluster network addresses into network addresses for application resources deployed on the node.

17. The non-transitory machine-readable medium of claim 13, wherein:
each agent is deployed as a set of containers; and
the set of instructions for monitoring status of the deployed agents comprises a set of instructions for communicating with the container cluster control plane to retrieve status of the deployed agents.

18. The non-transitory machine-readable medium of claim 13, wherein the set of instructions for preventing the container cluster control plane from deploying application resources to the particular node comprises sets of instructions for (i) modifying a custom configuration resource used to track status of the agents and (ii) modifying a conditions field stored by the container cluster control plane for the particular node to indicate that networking is not available on the particular node.

19. The non-transitory machine-readable medium of claim 18, wherein when the conditions field indicates that networking is not available on the particular node, the container cluster control plane (i) does not deploy new containers to the particular node and (ii) moves any containers running on the particular node to other nodes in the container cluster.

20. The non-transitory machine-readable medium of claim 13, wherein:
the container cluster is a Kubernetes cluster and each deployed agent is an instance of a replicable Pod; and
each deployed agent is an instance of a DaemonSet defined for the Kubernetes cluster.

21. An electronic device comprising:
a set of processing units; and
a non-transitory machine-readable medium storing a program which when executed by at least one of the processing units monitors a container cluster comprising a plurality of nodes on which a plurality of application resources are deployed, the program comprising sets of instructions for:
deploying an agent on each node of a set of nodes of the cluster, each agent for configuring a logical network on the node to which the agent is deployed;
monitoring status of the deployed agents; and
upon detection that a particular agent on a particular node is no longer operating correctly, preventing a container cluster control plane from deploying application resources to the particular node.
